(19) United States
(12) Patent Application Publication
(10) Pub. No.: US 2009/0064616 A1
(43) Pub. Date: Mar. 12, 2009

(54) FLOOR SYSTEM FOR A GRAIN BIN

(76) Inventors: Yuquin Shan, Winnipeg (CA); Bruce Allen, Selkirk (CA)

Correspondence Address: ADE & COMPANY INC., 2157 Henderson Highway, WINNIPEG, MB, R2G1P9, CA

(21) Appl. No.: 11/851,488

(22) Filed: Sep. 7, 2007

(51) Int. Cl. E04B 5/02; E04B 5/40; E04C 2/08; E04C 2/30; E04H 7/22; F26B 25/10

(52) U.S. Cl. 52/302.2

(57) ABSTRACT

A floor system includes floor planks and supports for supporting the planks. Each plank is formed from sheet metal to define three depending legs with the first and third legs shaped such that the first leg of a second plank can inter-engage with the third leg. Each support is formed from sheet metal folded to define a top rail, a bottom and a plurality of spaced posts arranged in a row along the rails. A first plank has the first leg located on the top rail over the first post, the second leg located over the second post, and the third leg interlocked with the first leg of the next plank located over the third post. The second plank has the second leg over a fourth post and the remainder extending beyond the rail to engage a next support. The supports are bent and include gripping tangs to hold the planks in place.

This invention relates to a floor system for a grain bin for mounting on a base pad of a grain bin having a plurality of floor planks shaped and arranged to be located in parallel side by side relationship to form a horizontal floor surface for receiving particulate material thereon to be stored in the bin and a plurality of support elements for supporting the planks at a height spaced from the base pad.

### BACKGROUND OF THE INVENTION

Grain bin floors of this general type are well known and many different designs have been proposed.

In U.S. Pat. No. 4,073,110 (Kennedy) issued Feb. 14, 1978 and U.S. Pat. No. 4,137,682 (Trumper) issued Feb. 6, 1979 are disclosed typical examples where the perforated sheet metal floor planks have side channels which provide an interlock and sit on sheet metal support elements which are generally C-shaped in plan which engage and locate the side channels to provide an interlocking system with limited possibility for the support elements to topple.

In U.S. Design Pat. No. 246,388 (Shivvers) issued Nov. 15, 1977 was disclosed a plank which has an additional center leg between the two side channels so that each plank is supported on the three parallel legs so defined allowing a wider plank to be used. This product has been sold widely for many years.

Similar interconnecting planks with three or more legs and interconnection between a leg on one side and a leg on the other side of the next plank are shown in U.S. Pat. No. 3,555,762 (Costanzo) issued Jul. 8, 1968 and U.S. Pat. No. 3,043,407 (Marryaft) issued Apr. 28, 1968. In some cases the planks are formed by longitudinal extrusion but in respect of bin floors it is typical that the planks are formed by bending sheet metal.

In US Patent Application No: 2004/0187416 published Sep. 30, 2004 by Grossman is disclosed an arrangement which utilizes the above techniques of the three leg plank of Shivvers and a triangular center leg of Marryatt It uses the sheet metal construction of Shivvers and connects the center leg to form a connected structure of Marryatt by using the well known technique of stitching the center leg shown for example in U.S. Pat. No. 5,287,671 issued Feb. 22, 1994 by Ueki and otherwise widely known and used in sheet metal forming techniques.

The supports for the planks can be of the type disclosed in Kennedy and Trumper above but if additional strength is required to support larger loads alternative constructions have been proposed. Thus in FIG. 8 of U.S. Pat. No. 3,979,871 (Pollock) issued Sep. 14, 1976 is proposed a sheet metal support formed by bending to defined upstanding post portions and transverse rail portions.

Such constructions have also been proposed using welding techniques to connect rod or angle members defining the top and bottom rails with posts formed by rods or tubes. Examples are shown in U.S. Pat. No. 4,281,489 (Kallestad) issued Aug. 4, 1981 and U.S. Pat. No. 4,282,694 (Mead) issued Aug. 11, 1981. Kallestad provides portions of the support bent at right angles at the ends to provide stability. Mead provides a support which is curved along its length for stability and where the vertical flange of the top angle is cut out to locate the legs of the planks.

Another similar example is shown in U.S. Pat. No. 3,426,445 (Steffen) issued Jul. 30, 1964 which uses a wire grid as the support which carries a transverse plank actually supporting the floor planks.

The formation of floor supports or floor joists from sheet metal by cutting and bending is well known and such arrangements are manufactured for example by Vicwest of Oakville Ontario Canada under the trademark “Thermasteel”. These provide a top rail and a bottom rail connected by a series of posts where the whole structure is formed from an integral piece of sheet metal cut to form openings and bent to form the rails and posts. Also such similarly formed structures including rails and posts when turned through 90 degrees are used as ladders for grain bins.

In Published US Application No: 2006/0090413 published May 4, 2006 by Grossman is disclosed a support of the shape using end stabilizing portions at right angles to the support previously disclosed by Kallestad but manufactured using the well known cutting and bending technique from sheet metal. This allows the columns or posts to have apertures for increased air flow.

None of these constructions is entirely satisfactory leaving opportunity for yet further improvements in this field.

### SUMMARY OF THE INVENTION

It is one object of the invention to provide an improved bin floor system of the above general type.

According to one aspect of the invention there is provided a floor system for mounting on a base pad of a grain bin, the floor system comprising:

a plurality of floor planks shaped and arranged to be located in parallel side by side relationship to form a horizontal floor surface for receiving particulate material thereon to be stored in the bin;

and a plurality of support elements for supporting the planks at a height spaced from the base pad;

each plank being formed from an integral piece of sheet metal;

each plank being shaped to define a first and a second longitudinally extending parallel side by side floor panel portion lying in a common plane to define the floor surface;

each plank being shaped to define three longitudinally extending support legs at spaced positions across the plank including a first leg along one edge of the first panel portion, a second center leg between the first and second panel portions and a third leg along an edge of the second panel portion opposite to the first leg;

the first and third legs being shaped such that the first leg of a second plank can inter-engage with the third leg of a first next adjacent plank to hold the planks side by side;

each support element being formed from an integral piece of sheet metal;

each support element being shaped to define a top rail for engaging the planks, a bottom rail for engaging the pad and a plurality of spaced posts arranged in a row along the rails joining the top rail to the bottom rail to transfer loads therebetween with an opening defined between each post and the next;

each support element having first, second, third and fourth posts only with the first post substantially at a first end of the rails, the fourth post substantially at a second end of the rails and the second and third posts as intermediate posts;

the rails and the posts of each support element being arranged such that a first plank, when located on the support element, has the first leg thereof located on the top rail over the first post to transfer loads thereto, the second leg thereof located on the top rail over the second post to transfer loads thereto, and the third leg thereof located on the top rail over the third post to transfer loads thereto;

the rails and the posts of each support element being arranged such that a second plank, when located on the support element, has the first leg thereof interlocked with the third leg of the first plank and located on the top rail over the third post to transfer loads thereto, the second leg thereof located on the top rail over the fourth post to transfer loads thereto, and the second panel portion and the third leg thereof extending beyond the second end of the rails.

Preferably each support element is formed from an integral piece of sheet metal to define the top rail, bottom rail and posts. This technique of punching openings in the sheet and bending the sheet to form the required components from the single sheet is well known and widely used and provides an inexpensive construction technique. However it is not essential to the construction of the present invention.

The term “grain bin” is of course a commonly used term of art and is not intended to be limited to specific crop types or particular materials to be stored since such bins commonly are used for different crops depending on the geographical location.

The posts between the rails are preferably formed by bending the sheet metal material into channels defined by three sides at right angles. However the posts may comprise any number of sides bent at angels to one another from two sides forming an angle, three sides forming a Z-shape, four sides forming a rectangle or more sides. The posts can thus be provided by any arrangement of bent metal sheets which provide sufficient strength to transfer loads between the top and bottom rails.

The top rail and the bottom rail may include a horizontal flange turned to lie flat over the posts and preferably include a flange which is turned down at right angles to the horizontal flange to provide additional strength. However this is not essential and the simple horizontal flange may suffice to provide the necessary strength.

The term “base pad” generally relates to a concrete base on which the floor planks are supported to provide an air channel underneath the floor for drying the stored materials. However it is not intended to be limited to any particular construction of or material for such a pad.

Preferably there is provided at least one engagement element connecting at least one of the planks and the top rail to locate the planks at a required position along the top rail to locate the legs at the posts.

Preferably the at least one engagement element comprises a projecting element connected to and extending upwardly from the top rail.

Preferably the at least one engagement element comprises a tang portion integrally formed with and extending upwardly from the horizontal flange of the top rail and more preferably a pair of tang portions integrally formed with a horizontal flange of the top rail and extending upwardly therefrom at positions thereon spaced by the width of the first plank to engage side edges of the first plank.

Preferably each tang portion has a base integrally connected to the top rail and an engagement portion which is of inverted V-shape to define an inwardly facing edge for gripping a respective side edge of the plank. This edge may be serrated for increased gripping action on the side of the plank. The side edge of the plank may be formed with a groove for receiving and co-operating with the edge of the tang portion.

Preferably each post is formed by bending a sheet along two parallel lines along the length of the post to define a back panel and two side panels.

Preferably on at least one of the posts the two side panels each have a recess therealong to provide increased longitudinal strength to the side panel.

Preferably the rails are bent at least at one location along their length about an axis parallel to the posts and spaced from the first and second ends so that the rails are non-linear to provide increased stability against toppling of the top rail to one side of the top rail and so that part of the top rail on each side of the bend axis extends outwardly from the bend axis across the plank to provide support for the plank at a position spaced outwardly of the bend axis. More preferably the rails are bent two locations along their length about two spaced axes each parallel to the posts. In this arrangement, the rails are preferably bent at the second post so as to define a V-shape with the first and third posts at ends of the V-shape and the second post at the apex of the V-shape. To provide additional strength to the structure, preferably the axis of bending at the one of the posts post extends along the post and includes a bend in the sheet metal defining the post.

According to a second aspect of the invention there is provided a floor system for mounting on a base pad of a grain bin, the floor system comprising:

a plurality of floor planks shaped and arranged to be located in parallel side by side relationship to form a horizontal floor surface for receiving particulate material thereon to be stored in the bin;

and a plurality of support elements for supporting the planks at a height spaced from the base pad;

each plank being formed from an integral piece of sheet metal;

each plank being shaped to define a longitudinally extending parallel floor panel portion lying in a plane to define the floor surface;

each plank being shaped to define two longitudinally extending side support legs;

the legs being shaped such that one side support leg of a second plank can inter-engage with one side support leg of a first next adjacent plank to hold the planks side by side;

each support element being shaped to define a top rail for engaging the planks, a bottom rail for engaging the pad and a plurality of spaced posts arranged in a row along the rails joining the top rail to the bottom rail to transfer loads therebetween with an opening defined between each post and the next;

the rails and the posts of each support element being arranged such that a first plank, when located on the support element, has the side support legs thereof located on the top rail over respective ones of the posts to transfer loads thereto;

and a pair of tang portions integrally formed with a horizontal flange of the top rail and extending upwardly therefrom at positions thereon spaced by the width of the first plank to engage side edges of the first plank.

According to a third aspect of the invention there is provided a floor system for mounting on a base pad of a grain bin, the floor system comprising

a plurality of floor planks shaped and arranged to be located in parallel side by side relationship to form a horizontal floor surface for receiving particulate material thereon to be stored in the bin;

and a plurality of support elements for supporting the planks at a height spaced from the base pad;

each plank being formed from an integral piece of sheet metal;

each plank being shaped to define a longitudinally extending parallel floor panel portion lying in a plane to define the floor surface;

each plank being shaped to define two longitudinally extending side support legs;

the legs being shaped such that one side support leg of a second plank can inter-engage with one side support leg of a first next adjacent plank to hold the planks side by side;

each support element being shaped to define a top rail for engaging the planks, a bottom rail for engaging the pad and a plurality of spaced posts arranged in a row along the rails joining the top rail to the bottom rail to transfer loads therebetween with an opening defined between each post and the next;

the rails and the posts of each support element being arranged such that a first plank, when located on the support element, has the side support legs thereof located on the top rail over respective ones of the posts to transfer loads thereto;

wherein the rails are bent at least at one location along their length about an axis parallel to the posts and spaced from the first and second ends so that the rails are non-linear to provide increased stability against toppling of the top rail to one side of the top rail and so that part of the top rail on each side of the bend axis extends outwardly from the bend axis across the plank to provide support for the plank at a position spaced outwardly of the bend axis.

According to a fourth aspect of the invention there is provided a floor system for mounting on a base pad of a grain bin, the floor system comprising:

a plurality of floor planks shaped and arranged to be located in parallel side by side relationship to form a horizontal floor surface for receiving particulate material thereon to be stored in the bin;

and a plurality of support elements for supporting the planks at a height spaced from the base pad;

each plank being formed from an integral piece of sheet metal;

each plank being shaped to define a first and a second longitudinally extending parallel side by side floor panel portion lying in a common plane to define the floor surface;

each plank being shaped to define three longitudinally extending support legs at spaced positions across the plank including a first leg along one edge of the first panel portion, a second center leg between the first and second panel portions and a third leg along an edge of the second panel portion opposite to the first leg;

the first and third legs being shaped such that the first leg of a second plank can inter-engage with the third leg of a first next adjacent plank to hold the planks side by side;

each support element being shaped to define a top rail for engaging the planks, a bottom rail for engaging the pad and a plurality of spaced posts arranged in a row along the rails joining the top rail to the bottom rail to transfer loads therebetween with an opening defined between each post and the next;

the plank having a width across the first and second panel portions equal to at least 9.0 inches.

### BRIEF DESCRIPTION OF THE DRAWINGS

One embodiment of the invention will now be described in conjunction with the accompanying drawings in which:

FIG. 1 is a plan view of a section of floor of a grain bin including a series of side by side floor panels connected parallel edge to edge shown in phantom and supported by a series of support elements underneath the panels.

FIG. 2 is a plan view on an enlarged scale of one of the support elements of FIG. 1.

FIG. 3 is front elevational view of a support element and the floor planks of FIG. 1.

FIG. 4 is an isometric view of the support element of FIG. 1.

FIG. 5 is a front elevational view of two of the support elements showing the floor planks in place on the support elements of FIG. 1.

FIG. 6 is a plan view of a blank for forming the support element of FIG. 2.

FIG. 7 is a front elevational view of the support of FIG. 2 formed from the blank of FIG. 6.

In the drawings like characters of reference indicate corresponding parts in the different figures.

### DETAILED DESCRIPTION

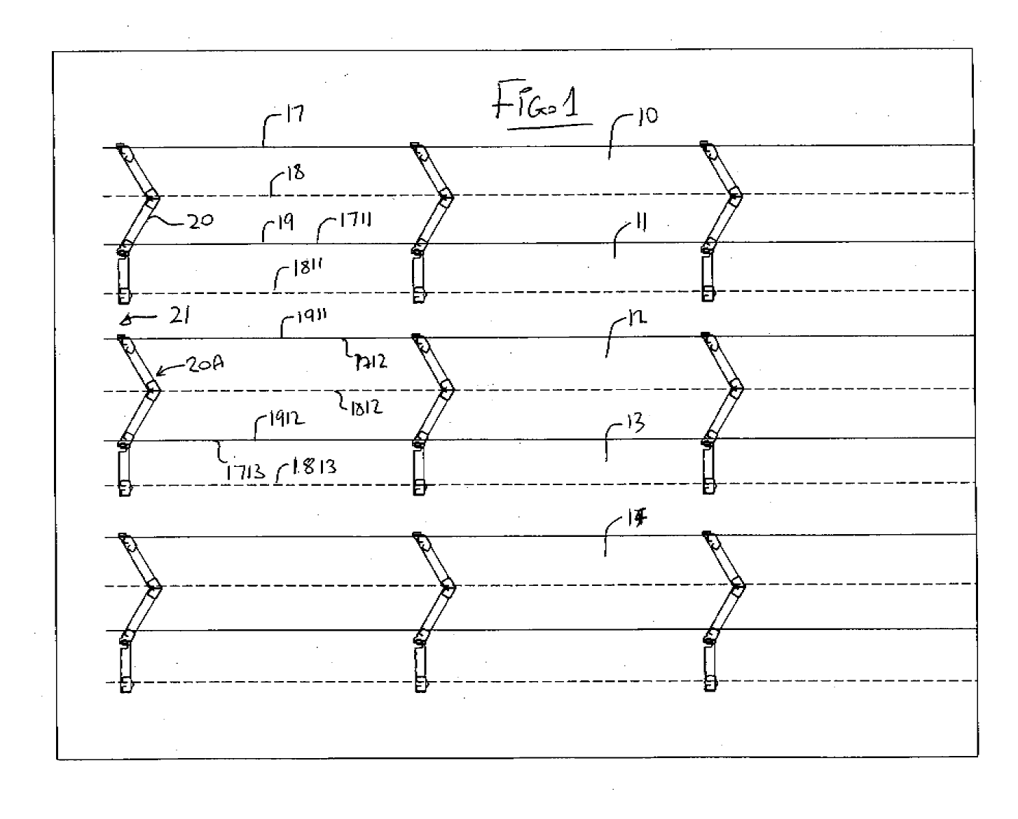

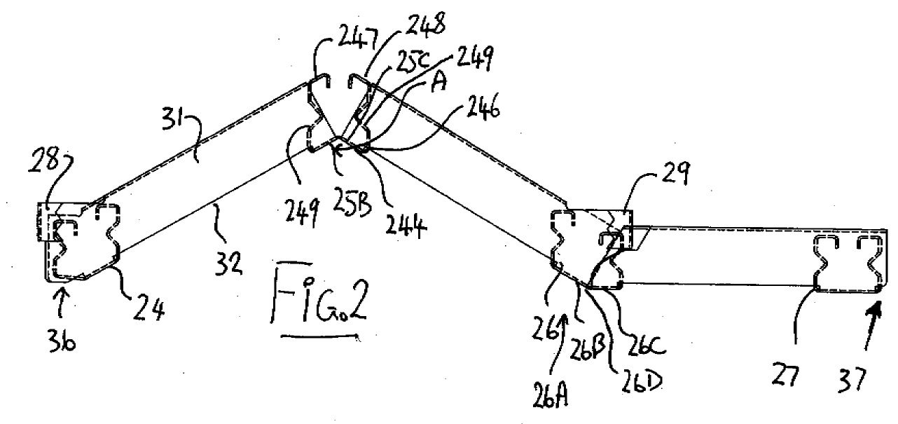

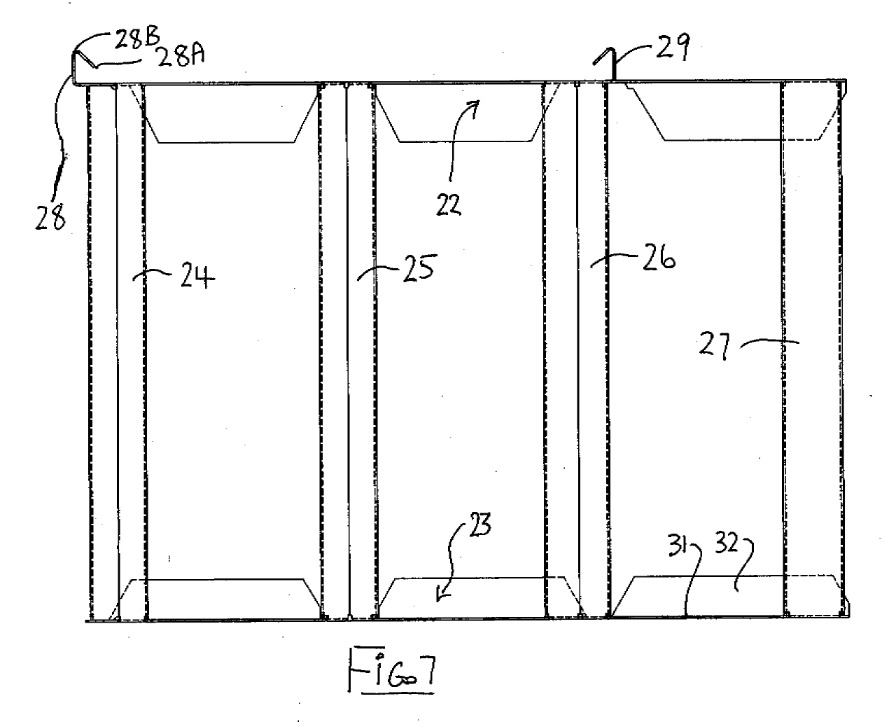

FIGS. 2, 6 and 7 show specifically and consistently a support for use in the arrangement of FIG. 1. The remaining figures show the supports more schematically and with some inconsistencies.

In FIG. 1 is shown a series of side by side floor planks 10, 111 12, 13, 14. These are arranged side by side and interconnected using techniques known from the prior art.

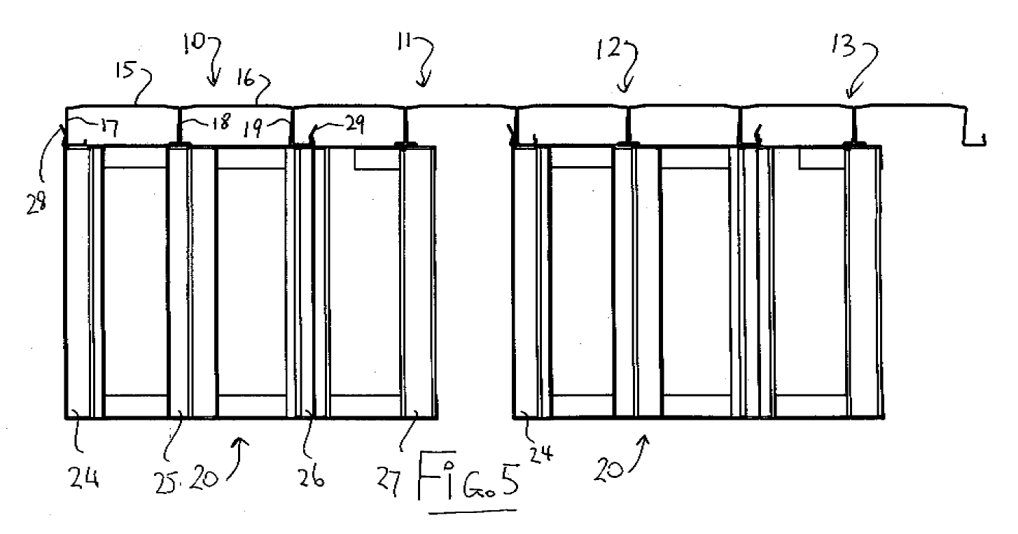

In one example of such a floor plank as shown in FIG. 5, the floor plank 10 includes two panel portions 15 and 16 and three supporting legs 17, 18 and 19. The first leg 17 formed by bending the sheet metal defining the plank downwardly includes a vertical portion 17A, a horizontal base flange portion 17B and an upturned portion 17C. The base portion 17B is turned inwardly underneath the panel 15.

The third leg 19 is similarly shaped to define a vertical portion 19A, a horizontal base portion 19B and an upturned flange portion 19C. The legs 19 and 17 are arranged so that the leg 17 which is the first leg of the plank 11 can snap fit into the channel portion defined by the leg 19 which is the third leg of the first plank 10. Thus the channel defined by the wall 17A, the base 17B and the upstanding flange 17C is shaped to receive inside that channel the channel defined by the leg 19. In this way the planks are inter-engaged and snap locked together side by side to be maintained in side by side fixed position by this inter-engagement. The second leg 18 is shaped as a generally inverted T-shape defined by two upstanding vertical portions 18A and 18B side by side which extend downwardly from the respective edges of the panels 15 and 16 together with a transverse flange piece 18C which interconnects the vertical pieces 18A and 18B and extends across the bottom end of those pieces. Thus the flange 1 8C forms a pad along the length of the plank having a width similar to the width of the bases 17B and 19B. In this way each plank is supported at three positions spaced across its width by the three legs and each leg has a base pad for resting upon a respective support.

The panels 15 and 16 are suitably perforated to allow the passage of air from the channel defined underneath the floor planks into the particulate material stored on top of the floor planks.

The two vertical legs 18A and 18B of the center or second leg 18 may be stitched or interconnected using conventional techniques so as to hold the vertical webs or plates together to form an integral leg structure commonly used in systems of this type.

The floor plank structure defined by the interconnected planks is supported by the series of support members 20. In FIG. 1 the first and third legs 17 and 19 are shown for convenience of illustration simply as a single line. The second or center leg 18 is shown for convenience of illustration simply as a dash line.

The planks are supported on a series of support elements 20 which are arranged in rows and columns so that each plank is supported along its length at spaced positions by separate support elements with the spacing between those support elements being suitable selected in accordance with conventional engineering calculations to provide the necessary support for the planks depending upon the load to be supported.

It will be noted from FIG. 1 that each support element 20 supports all three legs 17, 18 and 19 of the plank 10 and supports only the first leg 17/11 and the second 18/11 of the second plank 11. The third leg 19/11 is supported on the next adjacent support member indicated at 20A. The support element 20A also supports the legs 17/12 and 18112 and 19/12 of the plank 12 together with the legs 17/13 and 18/13 of the plank 13.

In effect, therefore, each support element supports effectively one and one half planks leaving a space between the element 20 and the element 20A which is free from support material as indicated at 21. This space between the elements thus reduces the amount of material necessary to provide the complete support for the floor planks.

It will be appreciated that the cost of the structure is very much determined by the amount of material used in the construction so that a reduction in the amount of material used by providing the spaces 21 between the support element and support element 20A together with further similar spaces between each further support elements in the next adjacent support element significantly reduces the amount of material used and thus significantly reduces the cost in comparison with a system which utilizes continuous support elements extending fully across the underside of all of the planks.

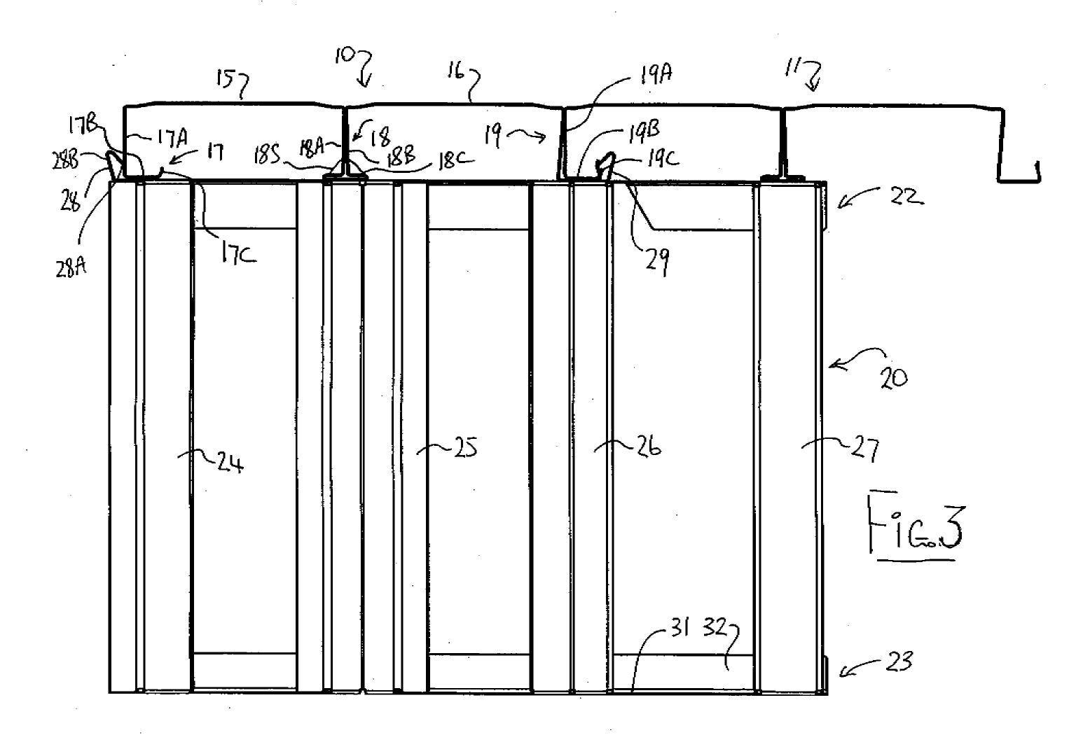

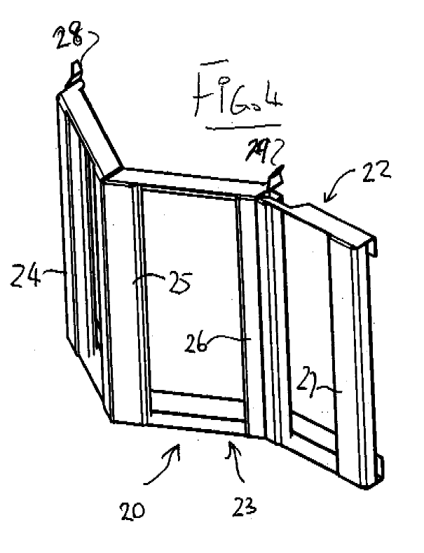

As best shown in FIGS. 3 and 4, each support element 20 comprises a top rail 22, a bottom rail 23 and a series of posts 24, 25, 26 and 27. The top rail 22 includes a pair of locating tangs 28 and 29 which stand upwardly from the top rail and define clip members or gripper members which engage the sides of the plank 10. The tangs 28 and 29 are formed by bending a portion of a horizontal top flange of the rail upwardly so as to provide elements which clip into suitable shaped grooves in the sides of the plank.

The support elements 20 are shaped and arranged so that the base plate of the leg 17 sits on top of structure of the post 24, the base plate 18C of the leg 18 sits on the structure of the post 25 and the base plate 19B of the leg 19 sits on the structure of the post 26 so that the loads applied to the support from the plank are communicated into the top rail and from the top rail into the posts and directly through the posts to the bottom rail.

The bottom rail sits on a pad which maybe a concrete pad from which the floor planks are supported so as to provide the air space underneath the floor planks and above the pad through which air can be supplied for passage through the floor planks.

The arrangement where the loads from the legs are directly applied to the posts of course provides a more effective transfer of loads without the loads being transferred significantly through the structure of the top rail.

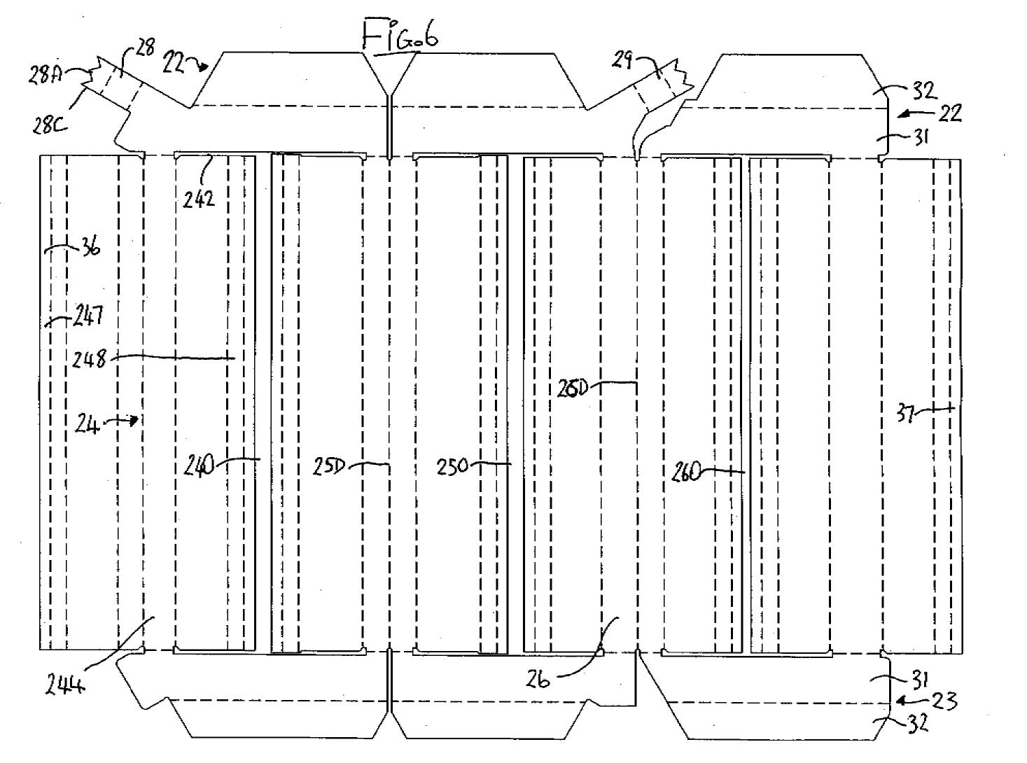

As best seen by comparing the blank of FIG. 6 with the assembled construction in FIG. 2 and 3, the top and bottom rails are formed by bending a horizontal flange 31 to lie flat on top of the posts together with a further flange 32 which is bent downwardly at the edge of the horizontal flange 31 to provide structural strength to the horizontal flange. The horizontal flange 31 and the vertical flange piece 32 are both separated into pieces and do not extend along the full length of the rail. In some locations the stiffening flange 32 may not be necessary at all in some cases depending upon the gauge of the material selected and the structure and arrangement of the posts and rails. Thus the specific instruction of the top rail and the bottom rail will vary in accordance with engineering requirements with the intention that the top and bottom rails provide a structural connection between the posts with the main loading being transferred through the posts from the floor planks to the pad.

Each of the posts is formed from an integral piece of sheet metal with the top and bottom rail by cutting openings 240, 250 and 260 within the sheet between the posts, above the bottom rail as indicated at 241 and below the top rail as indicated at 242 so as to distinguish each post from the next. The slits 241 and 242 are cut at the top and bottom rail to form a sheet of metal which can be bent to define the post. The sheet is connected to the top and bottom rail at a center post panel 244 where no bending is required. The sheet is separated from the top and bottom rail where bending from the plane of the sheet is required. As shown each post includes two sides panels 245 and 246 bent at right angles to the center panel 244. Outer end panels 247 and 248 are bent again at right angles to the panels 245 and 246. Each of the side panels 246 and 247 has a center longitudinal recess 249 along its full length to provide additional stiffness to that panel. The arrangement as shown provides a simple construction of the posts with a limited number of bends in the forming process.

Alternatively, depending upon the forces to be accommodated through the respective post, the post can be formed by 2, 3, 4 or more separate panels of the sheet material. Two such panels can be bent into an angle to form a post simply formed by a flange lying in the plane and a flange at right angles to the plane. A post can be formed by three such panels each bent at a right angle to the next so as to form a channel. A post can be formed by four such panels each bent at right angles to the next to form a square tube. A further post can be formed in a Z-shape by three panels where one lies at right angles to the outer and the outer two are bent so as to project away from one another. More complex structures can be formed from additional panels.

The post 25 is formed from the center panel 244 which includes two pieces 25B and 25C bent at an angle A so that the support including the top and bottom rails are bent at this bend line 25D through the angle A.

The post 26 is formed from the center panel 26A which includes two pieces 26B and 26C bent at an angle B so that the support including the top and bottom rails are bent at this bend line 26D through the angle A.

The support is thus bent along its length at two axes or locations 25D and 26D so that it is non-linear and thus is resistant to toppling. These axes 25D and 260 are within the ends of the support and are located at or adjacent the posts 25 and 26. The angles or bend at the axes 25D and 26D is relatively small and certainly less than 90°. This forms the support into three separate pieces defined by the section extending from the post 25 to the post 24, the section between the posts 25 and 26 and a section at the other end extending from the post 26 toward the post 27. The axis 25D is defined within the structure of the post 25 and particularly in the center panel 244 so that the bending action forms the two pieces 25B and 25C at the bend line. Thus the support at the bend line is structurally strengthened by the formation of the bend line through the whole of the post rather than merely through the top and bottom rails.

The bend at the post 26 is less structurally significant so that it may be provided simply in the top and bottom rails as defined by the vertical flange piece 32 or it may be provided through the whole of the post 26 in the manner of the bend 26D.

The support thus defines a first end 36 and a second 37 with the distance between the ends 36 and 37 being approximately equal to 1½ times the width of a plank. The bend lines are located inwardly of these ends so that the whole of the support structure provides support for the planks and there are no end portions beyond the ends 36 and 37 which are redundant and provided merely for stability. Thus the stability of the structure to prevent toppling is provided by the generally V shaped section between the end 36 and the bend line 25D and between the bend line 25D and the post 26. This V-shape is relatively shallow having an angle at the order of 120° which is sufficient to merely move the bend line 25D out of the plane defined by the ends 36 and 37 sufficiently to one side so as to provide sufficient stability to prevent toppling.

The angle at the bend line 26D is one half of the angle A so that the portion between the bend line 35 and the end 37 lies in the common plane with the ends 36 and 37. This provides a simple structure where most of the structure lies in the common plane with simply enough distortion from the common plane to prevent a toppling effect. Very little additional material is required as there are no right angle end pieces provided solely for stability.

The tang elements 28 and 29 or gripper elements are formed as an integral element with the top flange 31 at ends of the top flange 31. Thus the top flange 31 terminates at the end 36 and a portion of metal projecting beyond that end is turned upwardly toward the tang 28. The tang 29 is formed at the bend line 26D where an end portion of the flange 31 projects outwardly beyond the end of that flange and is turned upwardly to form the tang 29.

These tangs thus stand up from the top rail and are used to engage the sides of the plank 10. Thus as best shown in FIGS. 3 and 5, the tang 28 engages the outside surface of the vertical flange 17A of the leg 17 of the plank. At the opposite end the tang 29 engages the outside surface of the vertical flange 19C of the leg 19.

The tang and the surfaces which the tang engages may be suitably shaped with a groove to provide an effective gripping action.

In the embodiment shown in FIG. 5, the tang forms a V-shape with the apex of the V facing inwardly toward the opposite tang. This apex then engages into a corresponding recess in the surface of the plank.

In the embodiment shown in FIG. 3, the tang is arranged to be more aggressive since the V-shaped is turned in the opposite direction so that an edge 28A of the tang spaced from the apex 28B and projecting inwardly therefrom engages on to the side of the plank. This edge 28A can also carry teeth 28C (FIG. 6) to provide an increased gripping action if required. As shown in FIG. 5, the support is thus formed by the four posts 24, 25, 26 and 27. The posts 24 and 27 are at the ends of the support. The posts 24, 25 and 26 support the three legs of the plank 10. The remaining portion of the support from the post 26 to the post 27 projects outwardly beyond the end of the plank 10 and provides support for the plank 11 but only partial support therefore since the third leg of the plank 11 is supported on the post 24 of the second support. Thus the first support on the left hand side provides support for the first plank and one half of the second plank 11 and the second support provides support for the third plank 12, for part of the second plank 11 and for part of the third plank 13. It will be appreciated that the arrangement is symmetrical and continuous throughout the width of the grain bin floor.

The post 24 of the second support receives the first leg 17 of the plank 12 and the third leg 19 of the second plank 11. Thus the tang 28 at the second support engages the side surface of the flange 19A of the third leg 19 of the plank 11 rather than the side surface of the first leg 17 of the plank 12. Both legs may therefore be notched with the notch 17F to engage the edge 28A of the tang.

The width of each plank is arranged to be equal to at least 9.0 inches and preferably a total of 10.0 inches between the vertical flange 17A and the vertical flange 19A so that the width across the two panels 15 and 16 is equal to 10.0 inches. This width has been found to be particularly effective in reducing the number of planks required while providing a plank which is manageable in weight and size in the installation process. Typical prior art planks are of a reduced width of the order of 7″ or 8″ and this has been accepted as a standard in the industry. It has been found that increasing the width of the plank from the standard to a greater width of at least 9.0 and preferably equal to 10.0 inches provides a particularly effective arrangement maximizing the efficiency of material use.

The support column posts 24, 25, 26 and 27 as shown in FIG. 2 are shaped relative to the top rail flange 31 to provide as many contact points as possible at the top of the posts which provide support for the horizontal rails 17B, 18C and 19B of the floor planks. This is to avoid localized buckling on the contact points which can be caused where there is a very small contact area, which in some situations might be only one point. With this configuration as shown, the floor plank rails will bear against as much as four points of the posts at the inner and outer flat surfaces of the posts and the two sides of the “V” indentations 249 which are pushed in from the side. The primary load transfer point on the outside legs of the floor plank is along the vertical plane of the leg and this vertical plane is supported at multiple points on the post so that no local buckling occurs. The same issue occurs, although to a lesser extent, in the middle floor plank support leg.

The top flange 31 on the floor supports also is arranged to lay over these multiple contact points to fill the interstitial space, as much as possible. This is not altogether possible on the post 25 that supports the center leg 18 on the floor plank, due to the reverse bend but this location is not as great a concern as with the outer legs 17 and 19 of the planks.

The posts are configured such the multiple support points occur under this vertical plane in the outer legs 17 and 19 of the floor plank when the supports are rotated through 180 degrees, or reversed, with respect to the floor planks since the supports should work when configured in either direction with respect to the planks.

The tangs 28 and 29 on the support columns that grip the sides of the floor plank are positioned in a common vertical plane at right angles to the longitudinal direction of the plank which contains the center of gravity of the support. In this way, if for any reason the support becomes suspended from the floor planks, it hangs straight down and there is less tendency for it to pry off under its own weight.

The floor plank as shown in FIG. 3 includes a series of staking bends 18S along the center leg on each side. This is an upward diagonal punching of the junction between the vertical plates 18A and the horizontal plate 18C on one side and between the vertical plate 18B and the horizontal plate 18C on the other side. Staking is a known and conventional method to stiffen such right angle members. This is a lateral stability feature that is included to keep the legs from collapsing sidewise under loading.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A floor system for mounting on a base pad of a grain bin, the floor system comprising:
a plurality of floor planks shaped and arranged to be located in parallel side by side relationship to form a horizontal floor surface for receiving particulate material thereon to be stored in the bin;
and a plurality of support elements for supporting the planks at a height spaced from the base pad;
each plank being formed from an integral piece of sheet metal;
each plank being shaped to define first and second longitudinally extending parallel side by side floor panel portions lying in a common plane to define the floor surface;
each plank being shaped to define three longitudinally extending support legs at spaced positions across the plank including a first leg along one edge of the first panel portion, a second center leg between the first and second panel portions and a third leg along an edge of the second panel portion opposite to the first leg;
the first and third legs being shaped such that the first leg of a second plank can inter-engage with the third leg of a first next adjacent plank to hold the planks side by side;
each support element being shaped to define a top rail for engaging the planks, a bottom rail for engaging the pad and a plurality of spaced posts arranged in a row along the rails joining the top rail to the bottom rail to transfer loads therebetween with an opening defined between each post and the next;
each support element having first, second, third and fourth posts only with the first post substantially at a first end of the rails, the fourth post substantially at a second end of the rails and the second and third posts as intermediate posts;
the rails and the posts of each support element being arranged such that a first plank, when located on the support element, has the first leg thereof located on the top rail over the first post to transfer loads thereto, the second leg thereof located on the top rail over the second post to transfer loads thereto, and the third leg thereof located on the top rail over the third post to transfer loads thereto;
the rails and the posts of each support element being arranged such that a second plank, when located on the support element, has the first leg thereof interlocked with the third leg of the first plank and located on the top rail over the third post to transfer loads thereto, the second leg thereof located on the top rail over the fourth post to transfer loads thereto, and the second panel portion and the third leg thereof extending beyond the second end of the rails.

2. The floor system according to claim 1 wherein each support element is formed from an integral piece of sheet metal to define the top rail, bottom rail and posts.

3. The floor system according to claim 1 wherein there is provided at least one engagement element connecting at least one of the planks and the top rail to locate the planks at a required position along the top rail to locate the legs at the posts.

4. The floor system according to claim 3 wherein the at least one engagement element comprises a projecting element connected to and extending upwardly from the top rail.

5. The floor system according to claim 3 wherein the at least one engagement element comprises a tang portion integrally formed with and extending upwardly from a horizontal flange of the top rail.

6. The floor system according to claim 5 wherein the at least one engagement element comprises a pair of tang portions integrally formed with a horizontal flange of the top rail and extending upwardly therefrom at positions thereon spaced by the width of the first plank to engage side edges of the first plank.

7. The floor system according to claim 6 wherein each tang portion has a base integrally connected to the top rail and an engagement portion which is of inverted V-shape to define an inwardly facing edge for gripping a respective side edge of the plank.

8. The floor system according to claim 1 wherein each post is formed by bending a sheet along two parallel lines along the length of the post to define a back panel and two side panels.

9. The floor system according to claim 8 wherein on at least one of the posts the two side panels each have a recess therealong to provide increased longitudinal strength to the side panel.

10. The floor system according to claim 1 wherein the rails are bent at least at one location along their length about an axis parallel to the posts and spaced from the first and second ends so that the rails are non-linear to provide increased stability against toppling of the top rail to one side of the top rail and so that part of the top rail on each side of the bend axis extends outwardly from the bend axis across the plank to provide support for the plank at a position spaced outwardly of the bend axis.

11. The floor system according to claim 10 wherein the rails are bent at two locations along their length about two spaced axes each parallel to the posts.

12. The floor system according to claim 10 wherein the rails are bent at the second post so as to define a V-shape with the first and third posts at ends of the V-shape and the second post at the apex of the V-shape.

13. The floor system according to claim 10 wherein the axis of bending at the one of the posts post extends along the post and includes a bend in the sheet metal defining the post.

14. A floor system for mounting on a base pad of a grain bin, the floor system comprising:
a plurality of floor planks shaped and arranged to be located in parallel side by side relationship to form a horizontal floor surface for receiving particulate material thereon to be stored in the bin;
and a plurality of support elements for supporting the planks at a height spaced from the base pad;
each plank being formed from an integral piece of sheet metal;
each plank being shaped to define a longitudinally extending parallel floor panel portion lying in a plane to define the floor surface;
each plank being shaped to define two longitudinally extending side support legs;
the legs being shaped such that one side support leg of a second plank can inter-engage with one side support leg of a first next adjacent plank to hold the planks side by side;
each support element being shaped to define a top rail for engaging the planks, a bottom rail for engaging the pad and a plurality of spaced posts arranged in a row along the rails joining the top rail to the bottom rail to transfer loads therebetween with an opening defined between each post and the next;
the rails and the posts of each support element being arranged such that a first plank, when located on the support element, has the side support legs thereof located on the top rail over respective ones of the posts to transfer loads thereto;
and a pair of tang portions integrally formed with a horizontal flange of the top rail and extending upwardly therefrom at positions thereon spaced by the width of the first plank to engage side edges of the first plank.

15. The floor system according to claim 14 wherein the tang portions lie in a common vertical plane extending at right angles to the length of the plank, which plane contains the center of gravity of the support.

16. The floor system according to claim 14 wherein each tang portion has a base integrally connected to the horizontal flange of the top rail and an engagement portion which is of inverted V-shape to define an inwardly facing edge for gripping a respective side edge of the plank.

17. The floor system according to claim 14 wherein each post is formed by bending a sheet along two parallel lines along the length of the post to define a back panel and two side panels.

18. The floor system according to claim 17 wherein on at least one of the posts the two side panels each have a recess therealong to provide increased longitudinal strength to the side panel.

19. The floor system according to claim 14 wherein the rails are bent at least at one location along their length about an axis parallel to the posts and spaced from the first and second ends so that the rails are non-linear to provide increased stability against toppling of the top rail to one side of the top rail and so that part of the top rail on each side of the bend axis extends outwardly from the bend axis across the plank to provide support for the plank at a position spaced outwardly of the bend axis.

20. The floor system according to claim 19 wherein the rails are bent at two locations along their length about two spaced axes each parallel to the posts.

21. The floor system according to claim 19 wherein the rails are bent at a second post so as to define a V-shape with a first and a third post at ends of the V-shape and the second post at the apex of the V-shape.

22. The floor system according to claim 19 wherein the axis of bending at the one of the posts post extends along the post and includes a bend in the sheet metal defining the post.

23. A floor system for mounting on a base pad of a grain bin, the floor system comprising:
a plurality of floor planks shaped and arranged to be located in parallel side by side relationship to form a horizontal floor surface for receiving particulate material thereon to be stored in the bin,
and a plurality of support elements for supporting the planks at a height spaced from the base pad;
each plank being formed from an integral piece of sheet metal;
each plank being shaped to define a longitudinally extending parallel floor panel portion lying in a plane to define the floor surface;
each plank being shaped to define two longitudinally extending side support legs;
the legs being shaped such that one side support leg of a second plank can inter-engage with one side support leg of a first next adjacent plank to hold the planks side by side;
each support element being formed from an integral piece of sheet metal;
each support element being shaped to define a top rail for engaging the planks, a bottom rail for engaging the pad and a plurality of spaced posts arranged in a row along the rails joining the top rail to the bottom rail to transfer loads therebetween with an opening defined between each post and the next;
the rails and the posts of each support element being arranged such that a first plank, when located on the support element, has the side support legs thereof located on the top rail over respective ones of the posts to transfer loads thereto;
wherein the rails are bent at least at one location along their length about an axis parallel to the posts and spaced from the first and second ends so that the rails are non-linear to provide increased stability against toppling of the top rail to one side of the top rail and so that part of the top rail on each side of the bend axis extends outwardly from the bend axis across the plank to provide support for the plank at a position spaced outwardly of the bend axis.

24. The floor system according to claim 23 wherein each support element is formed from an integral piece of sheet metal to define the top rail, bottom rail and posts.

25. The floor system according to claim 23 wherein the rails are bent two locations along their length about two spaced axes each parallel to the posts.

26. The floor system according to claim 25 wherein the rails are bent at a second post so as to define a V-shape with a first and a third post at ends of the V-shape and the second post at the apex of the V-shape.

27. The floor system according to claim 23 wherein the axis of bending at the second post extends along the post and includes a bend in the sheet metal defining the post.

28. The floor system according to claim 23 wherein each post is formed by bending a sheet along two parallel lines along the length of the post to define a back panel and two side panels

29. The floor system according to claim 28 wherein on at least one of the posts the two side panels each have a recess therealong to provide increased longitudinal strength to the side panel.

30. A floor system for mounting on a base pad of a grain bin, the floor system comprising:
a plurality of floor planks shaped and arranged to be located in parallel side by side relationship to form a horizontal floor surface for receiving particulate material thereon to be stored in the bin;
and a plurality of support elements for supporting the planks at a height spaced from the base pad;
each plank being formed from an integral piece of sheet metal;
each plank being shaped to define a first and a second longitudinally extending parallel side by side floor panel portion lying in a common plane to define the floor surface;
each plank being shaped to define three longitudinally extending support legs at spaced positions across the plank including a first leg along one edge of the first panel portion, a second center leg between the first and second panel portions and a third leg along an edge of the second panel portion opposite to the first leg;
the first and third legs being shaped such that the first leg of a second plank can inter-engage with the third leg of a first next adjacent plank to hold the planks side by side;
each support element being shaped to define a top rail for engaging the planks, a bottom rail for engaging the pad and a plurality of spaced posts arranged in a row along the rails joining the top rail to the bottom rail to transfer loads therebetween with an opening defined between each post and the next;
the plank having a width across the first and second panel portions equal to at least 9.0 inches.
